(19) United States
(12) Patent Application Publication
(10) Pub. No.: US 2004/0026677 A1
(43) Pub. Date: Feb. 12, 2004

(54) Guardrail posts and spacer blocks made with recycled rubber from shredded tires

(76) Inventor: John Tikalsky, Discovery Bay, CA (US)

Correspondence Address: Patrick D. Kelly, 11939 Manchester #403, St. Louis, MO, 63131, US

(21) Appl. No.: 10/217,521

(22) Filed: Aug. 12, 2002

(51) Int. Cl. A01K 3/00; E01F 15/00

(52) U.S. Cl. 256/13.1

(57) ABSTRACT

Mounting posts and spacer blocks, for installing and supporting guardrails near roads and other conveyances, can be made from rubber particles that have been obtained from shredded discarded tires. The posts and spacer blocks can be manufactured in any desired lengths (which normally will range from about 1 to about 3 meters, or 3 to 10 feet long for the posts, and up to about 40 cm or 16 inches long for the spacer blocks), and any desired thicknesses (such as with square or rectangular cross-sections ranging from about 10 to about 25 cm, or 4 to 10 inches on each side). The molding process can use an adhesive or other chemical binding agent, and/or heat combined with pressure, and can be done in molding cavities or by extrusion. These posts must have levels of strength and durability which have been declared acceptable, in all respects, to at least one governmental agency which is responsible for purchasing guardrails for installation along highways. These posts and spacer blocks are not brittle, and have a consistency similar to wood, and can be sawed, drilled, and otherwise worked, using conventional tools. They are highly durable and weather-resistant, and will provide longer lifespans in outdoor conditions than wooden posts. These devices also eliminate various other problems associated with wooden posts (such as the leaching of toxic chemicals out of treated wood), and provide a highly useful method for recycling discarded tires that otherwise create solid waste and public health problems.

### BACKGROUND OF THE INVENTION

This invention is in the field of materials handling and recycling, and relates to using rubber from discarded tires to manufacture highly durable weather-resistant posts that can be used to install guardrails and similar devices alongside highways, roads, and other conveyances.

As used herein, the term “guardrail” includes all components that are part of a guardrail assembly that is designed to be installed alongside a highway or other road, or alongside a bridge, railroad track, bicycle path, hiking or jogging path, or other on-land pathway, or in any other location where a rail-like or fence-like structure, lower than shoulder-height, can provide enhanced safety or traffic control for vehicles, pedestrians, or other equipment or devices. This can include, for example, guardrails that are emplaced in parking lots or alongside docks, piers, or other waterways, or next to a scenic overlook, dangerous slope, etc. For convenience, the term “conveyance” is used to refer to any highway, road, bridge, railroad track, bicycling or jogging path, waterway, or other area, location, pathway or route where vehicular, bicycle, rail, or other traffic or pedestrian usage renders it desirable to place a guardrail, crash barrier, or similar structure.

It also should be understood that there is no clear distinction between guardrails and crash barriers; depending on the layout of a road and its accompanying safety devices at a certain location, a guardrail can serve as a crash barrier. Accordingly, the disclosures herein can also be adapted, using no more than routine skill in the art, to various other types of highway and/or traffic control or safety devices, such as the types of collapsible crash barriers that are often positioned at the point where a single lane on a highway divides into two different lanes, at an exit ramp or highway intersection.

Most commonly, a complete guardrail assembly will include a series of multiple mounting posts, driven into or emplaced in the ground, and positioned apart from each other in a suitable spaced manner (such as roughly 2 to 10 meters, or 6 to 30 feet, apart), depending on the traffic and safety needs of a specific location. These mounting posts will support an elongated horizontal piece or assembly, which constitutes the guardrail itself. Under the current art, most guardrails used along highways and roads are made from a galvanized steel strip that has a cross-sectional shape in the form of a rounded “W”. Among other advantages, these steel rails are fairly reflective and provide good visibility at night, and they are relatively inexpensive to manufacture and install, by assembling lightweight sections into any desired length (which can extend for numerous kilometers or miles at a stretch).

Other types of guardrails intended for other sites or uses can be made of other types of materials. For example, a guardrail intended for use alongside a bridge, pier, dock, or other coastal site generally should not be made of steel, because of corrosion problems that will be greatly accelerated by nearby salt water. Accordingly, such guardrails can be made of woods recycled plastic, molded rubber particles obtained from shredded tires as disclosed herein, or various other non-corroding materials.

As used herein, the terms “mounting post”, “guardrail post”, and “post” are used interchangeably, and include any type of mounting post that is used to install and hold a guardrail. Most commonly, these are oriented vertically, and are installed in either of two manners: (i) they are driven into the ground, using a large impact hammer mounted on the back of a tractor, backhoe, or similar powered unit; or, (ii) they are lowered into a hole that has been augured or otherwise dug into the ground, or cast or molded into a concrete structure, and after being emplaced at the desired height, they are secured firmly in place, such as by pouring concrete, asphalt, dirt, gravel, or other suitable material into the hole that surrounds the lower portion of the post.

It should also be noted that many guardrails (especially guardrails alongside highways and roads) also use devices, referred to by terms such as spacers, spacer blocks, spacer bars, mounting plates, mounting arms, etc., to help securely attach the horizontal rail to the vertical posts. Typically, each spacer component is bolted or otherwise secured to a single mounting post, and to either two guardrail components (at joint locations) or a single guardrail component (between joints). Large washers, small rectangular plates, or other devices (most commonly made of galvanized steel, for most roadside guardrails) are often used to render the connections stronger, more secure, and able to withstand with minimal tearing an accident involving one or more vehicles.

In the past, the large majority of mounting posts used for guardrails along highways and other roads have been made of various types of wood, including pine and various hardwoods. To help these types of wooden posts withstand termites, carpenter ants, mold, fungus, and other insects and microbes over a design life of multiple years, wooden posts must be treated with toxic chemicals, such as creosote, mixtures that contain arsenic, etc.

These factors lead to several very important disadvantages, including the following. First, since guardrail posts must be fairly thick (typical cross-sections are usually at least four inches square, and thicker posts are often required along highways that allow higher speeds and in various other locations), wooden guardrail posts usually can be made only from trees that are growing in “old growth” forests, rather than trees that have been grown on tree farms or planted under controlled conditions. For numerous reasons, cutting down trees from old-growth forests is not a desirable or optimal way to create millions of thick posts that likely will need to be replaced every few years.

Second: since most wooden guardrail posts are implanted in the ground, any toxic chemicals that have been impregnated into the wood will pose a major risk of leaching out over a span of years, and entering groundwater or surface water runoff. This poses a toxic chemical threat to wildlife, farming, drinking water, and nearby lakes, streams, and rivers.

And third: because of its nature, lumber that has been cut open and exposed to the soil and weather does not have a naturally long lifespan. This is especially true in regions where rainwater or melted snow that has seeped into cracks and crevices in the wood will undergo repeated cycles of freezing and thawing (that environment includes most of America and other temperate zones around the world during winter, since freezing temperatures will occur nearly every night, and some degree of thawing will occur on the surfaces of dark-colored objects nearly every day). Therefore, wooden guardrail posts have limited lifespans and need to be periodically replaced, usually at intervals that typically range from about 5 to about 15 years, depending on climate and other conditions at a specific location.

For all of these reasons, chemically-treated wooden posts are not environmentally sound, and their use is being phased out. Over roughly the past decade, most guardrail posts have been made instead from I-beams made of galvanized (zinc-coated) steel. However, galvanized steel posts also suffer from various limitations and shortcomings, including: (i) their expense, since they are made from high-value materials that have numerous other valuable and productive uses; (ii) the zinc coating, which protects the underlying steel against corrosion, is a surface coating only, and if the surface coating is scraped, punctured, or otherwise breached, the underlying steel becomes exposed and vulnerable, and often becomes a focal point or “hot spot” where rust will begin to attack the steel at an accelerated rate; (iii) because of the need to protect the zinc coating which protects the steel, these posts normally cannot be hammered into the ground, without increasing and accelerating the risk of corrosion, unless special steps (which increase installation costs) are taken to protect the top of each post while it is being hammered; and, (iv) the zinc that is used to galvanize these posts must be treated as a potentially toxic “heavy metal” when these posts are disposed of.

For all of these reasons, there is a need for a different type of material that can be used to manufacture mounting posts (and spacer plates) for guardrails. An ideal material for such use should be waterproof, bug-proof, non-brittle, easy to handle and work with (which includes being well-suited for drilling or sawing on-site), inexpensive, and free of toxic chemicals that might leach out and contaminate groundwater or surface water. In addition, posts made of an ideal material should have a very long lifespan, measured in multiple decades, even when the material is not coated with any type of protective coating, and even when the posts are constantly exposed to adverse weather.

Discarded Tires

As is well known, discarded tires pose a major solid waste problem. As used herein, all references to “tires” refer to vehicular tires, of the type used by automobiles, trucks, tractors, etc. All references to “rubber” refer to the elastomeric material contained in such tires, regardless of whether it is natural or synthetic rubber or a combination thereof, and regardless of whether such material also contains other materials (such as strands of steel or synthetic fibers such as nylon, which are commonly used to provide reinforcing belts in tires).

In the U.S. alone, hundreds of millions of discarded tires have accumulated in open-air dumps, where they generally form large mounds or even mountains of unwanted tires. When piled up in this manner, tires collect rainwater and form small puddles, which then become breeding sites for mosquitoes. Since mosquitoes pose a major annoyance, and carry various diseases that are invading the United States with increasing aggressiveness (including the West Nile virus, malaria, typhoid, and several types of tropical fevers, including yellow fever, dengue, etc.), discarded tires pose a serious and growing threat to public health. In addition, because discarded tires are often coated or stained with oil, grease, and other flammable solvents or compounds, large mounds of discarded tires often generate fires due to spontaneous combustion, and it is extremely difficult to extinguish such fires once they start.

Although numerous attempts have been made over at least the past three decades to provide alternate uses for discarded tires (including incineration, to obtain heat and energy for useful purposes), the fact remains that only a very small fraction of the total number of tires discarded each year are recycled, or incinerated in a useful manner. Instead of being recycled in a useful manner on a widespread basis, the sad fact is that most discarded tires continue to be sent to open-air dumps.

Additional background information on the need to recycle tires, on shredding equipment that can be used to shred tires into particles that can be molded into useful articles, on adhesives that can be used to bind rubber particles together, and on methods of mixing particles with adhesives and molding them into structural items, is provided in various patents, including U.S. Pat. No. 5,094,905 (which relates to making articles such as landscaping ties, floor mats, etc.) and U.S. Pat. No. 5,238,734 (which relates to making railroad ties), both issued to Murray and now owned by the same Applicant herein. The contents of those two patents is incorporated herein by reference. Additional information on adhesives that will bind tightly to rubber particles can be obtained from any vendor that sells adhesives to industrial purchasers.

The use for discarded tires that is of interest herein relates to particles, chunks, strips, or other pieces of rubber that have been obtained by cutting, chopping, or grinding up tires that have been discarded due to wear and abrasion, punctures, manufacturing defects, etc. Accordingly, all references herein to “tires” refers to discarded tires that normally would be regarded as solid waste, and that must be disposed of or recycled.

Unless otherwise specifically indicated, all references herein to terms such as particles, chunks, or rubber, are used interchangeably, and refer to pieces of rubber that have been obtained by passing a discarded tire through a shredding, chopping, cutting, grinding, or similar machine that is intended to reduce an intact tire or portion thereof into smaller pieces. As noted below, preferred preparations generally should contain a range of particle sizes, including chunks that have diameters of greater than an inch, mixed with smaller particles.

For convenience, the term “shredding” is used herein to refer to any type of cutting, chopping, grinding, or other “reducing” operation that cuts or tears apart intact tires or any portion thereof, to create smaller pieces. A shredding operation as contemplated herein can include a cutting or slicing operation that would generate elongated strips of rubber, since elongated strips can provide tensile reinforcement for elongated molded devices; however, a shredding operation, as contemplated for this particular invention, generally would not include an operation that removes intact sidewalls with ringed or annular shapes from tire carcasses.

Machines for shredding tires into particles of any desired size range are well-known in the art, and are commercially available from equipment manufacturers, and do not need to be discussed in detail herein. Very briefly, most such machines typically involve gravity-loaded bins, with rotating drums or disks at the bottom, which have protruding claws, blades, or other sharpened edges that interact with either (i) an anvil-type non-movable surface, or (ii) a second drum that is rotating in the opposite direction. As a tire at the bottom of the pile is pressed into the rotating disks by the weight of other tires loaded on top of it, the moving claws or other blades will catch on exposed surfaces of the tire, and tear into it. If desired, to speed up a shredding operation, tires can be cut into halves, quarters, or other sections, such as by a machine comparable to a large stamping press, prior to loading the tire sections into a shredding machine.

A number of prior art patents offer various proposals for making guardrails and/or mounting posts from recycled materials. However, to the best of the Applicant's knowledge, none of those proposals are actually being used on a commercial or public level, and none of those patents appear to disclose or suggest the invention herein. Instead, those patents describe various structures that have either or both of two limitations: (1) they are more complicated, and more expensive and difficult to manufacture and install in large numbers, than the mounting posts disclosed herein; and/or, (2) they require more expensive feedstock materials than disclosed herein, such as certain specified types of plastics, or combinations of rubber particles from discarded tires mixed with substantial fractions of virgin rubber, virgin plastic, or other relatively expensive materials.

Examples of such U.S. patents include:

U.S. Pat. No. 6,367,208 (Campbell et al 2002), in which recycled rubber or plastic must be used to encapsulate a “tensile element” comprising embedded sheet steel that must be pre-formed into a particular shape and length;

U.S. Pat. No. 6,308,936 (Atwood 2001), in which recycled plastic material is formed into blocks which must contain large radiused channels and large transverse voids, arranged in a way that reduces weight while maintaining adequate strength;

U.S. Pat. No. 5,660,375 (Freeman 1997), in which tubular guardrail posts are made from multiple layers of polyester, matt fiberglass, and longitudinal fiberglass;

U.S. Pat. No. 5,507,473 (Hammer et al 1996), in which a guardrail post is molded from recycled plastic material, which is molded around a vertical steel pipe as well as a horizontal reinforcing member, wherein the plastic contains 35% to 65% high density polyethylene, and 35% to 60% low density polyethylene;

U.S. Pat. No. 5,335,016 (Baatz 1994), in which a vehicle barrier is made from homogenous rubber, containing 80 to 90 percent waste rubber and 10 to 20% virgin rubber, with an accelerator composition also included, and with a finished outer surface of cured “uncontaminated” rubber with a specified hardness level; and,

U.S. Pat. No. 5,152,507 (Lee 1992), in which a hollow squared structure filled with foamed plastics is inserted into a second post that has already been buried in the ground; the complete assembly also requires a fixing frame, a corrugated connector plate, and a pair of guard plates.

All of these devices are more complex, more expensive, and probably more fragile and less durable than the mounting posts disclosed herein.

Accordingly, one object of this invention is to disclose a method of manufacturing mounting posts, which will support guardrails that are to be installed alongside highways and other conveyances, by using rubber particles obtained from shredded discarded tires.

Another object of this invention is to disclose guardrail mounting posts, made with rubber particles from shredded discarded tires.

Another object of this invention is to disclose spacer plates and other spacer devices which can be used to provide coupling interfaces between guardrails and guardrail mounting posts, and which are made with rubber particles from shredded discarded tires.

Another object of this invention is to disclose an improved method for recycling discarded tires, and an ideal use for rubber particles obtained by shredding discarded tires.

These and other objects of the invention will become more apparent through the following summary, drawings, and description of the preferred embodiments.

### SUMMARY OF THE INVENTION

Mounting posts and spacer blocks, for installing and supporting guardrails near roads and other conveyances, can be made from rubber particles that have been obtained from shredded discarded tires. The posts and spacer blocks can be manufactured in any desired lengths (which normally will range from about 1 to about 3 meters, or 3 to 10 feet long for the posts, and up to about 40 cm or 16 inches long for the spacer blocks), and any desired thicknesses (such as with square or rectangular cross-sections ranging from about 10 to about 25 cm, or 4 to 10 inches on each side). The molding or extrusion process can use an adhesive or other chemical binding agent, and/or heat combined with pressure. These posts must have levels of strength and durability which have been declared acceptable, in all respects, to at least one governmental agency which is responsible for purchasing guardrails for installation along highways. These posts and spacer blocks are not brittle, and have a consistency similar to wood, and can be sawed, drilled, and otherwise worked, using conventional tools. They are highly durable and weather-resistant, and will provide longer lifespans in outdoor conditions than wooden posts. These devices also eliminate various other problems associated with wooden posts (such as the leaching of toxic chemicals out of treated wood), and provide a highly useful method for recycling discarded tires that otherwise create solid waste and public health problems.

### BRIEF DESCRIPTION OF THE DRAWINGS

FIG. 1 is an exploded view of a highway guardrail section, showing a segment of a conventional rail 20 made of galvanized steel, attached via spacer block 30 to mounting post 40, wherein both the mounting post and the spacer block are made of rubber particles from shredded tires.

FIG. 2 is a flow-chart describing the steps used to manufacture mounting posts (or spacer blocks) from recycled rubber particles, in which a chemical binder is used to bind the rubber particles together.

FIG. 3 is a flow-chart describing the steps used to manufacture mounting posts (or spacer blocks) from rubber particles, in which heat is used to melt and soften a portion of the rubber particles, thereby allowing them to be used as the binding agent during a molding or extrusion process.

FIG. 4 is a cross-sectional view of a mounting post 50 having an internal reinforcing post and a tapered lower end, designed to be hammered into soil by a powered hammer system without using an augured hole.

FIG. 5 is a perspective view of a pallet designed to be lifted and transported by a forklift, with mounting posts resting upon and secured to the pallet.

### DETAILED DESCRIPTION

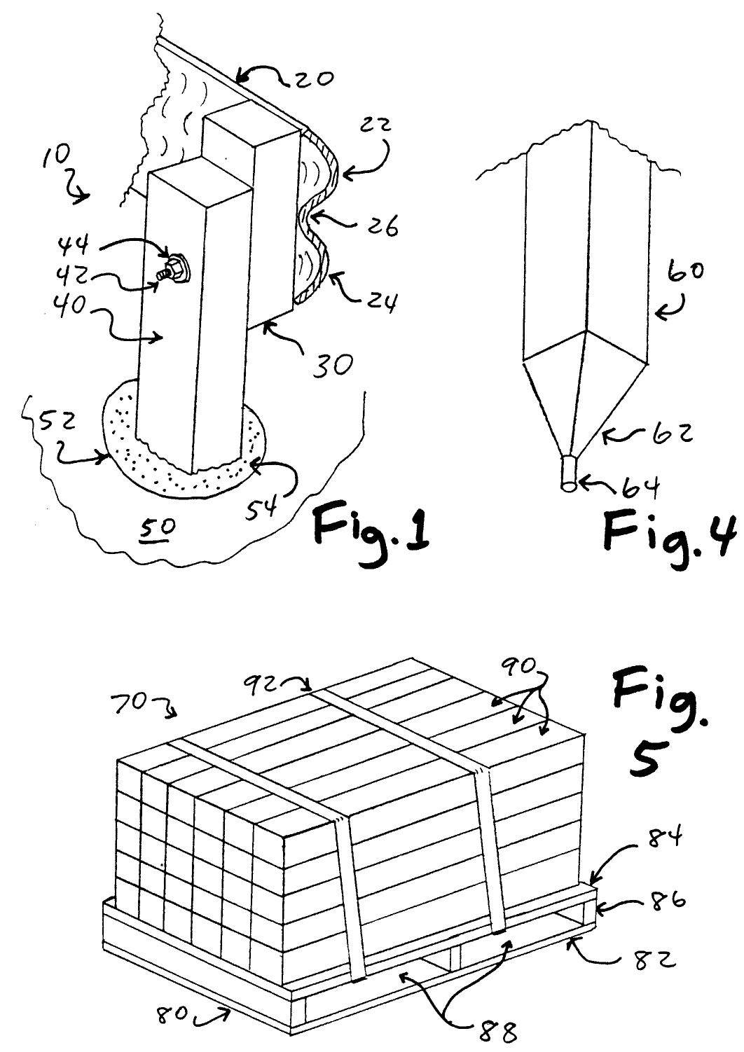

Referring to the drawings, callout number 10 in FIG. 1 refers to a guardrail-and-post assembly according to the present invention. The horizontal rail 20 in this embodiment is made of galvanized sheet steel, which has been shaped into a conventional “rounded W” configuration, with upper and lower crests 22 and 24 (which can also be called ridges, humps, etc.), and a center trough 26.

Rail 20 is securely coupled (such as by bolts and nuts, as shown) to spacer block 30 (which also can be called a spacer, adapter, mounting arm, etc). Spacer block 30 is securely coupled to the upper end of mounting post 40, which rests in ground 50. Either or both of the mounting post 40 and the spacer block 30 can be made of rubber particles from shredded tires, as disclosed herein (as defined above, the term “shredded” as used herein also includes chopped, sliced, grinded or ground, etc.).

Although FIG. 1 illustrates a rubber mounting post and a rubber spacer block, it should be noted that rubber spacer blocks also can be affixed (by bolts, etc.) to galvanized steel mounting posts. This configuration is likely to be useful in rocky and gravelly locations, where it would be easier to drive a steel I-beam into the ground, by hammering, than to dig a round augured hole. In addition, this configuration is likely to be used during the early stages of commercialization of this invention, while rubber-containing mounting posts must be tested over prolonged spans of time for durability, absence of potentially hazardous leachates, and other traits.

These types of rubber-containing devices must be suited in all respects (which implies and requires that they must have sufficient strength and durability) for installation and use as mounting posts and/or spacer blocks, to support guardrails alongside highways. Because various governmental agencies at the federal and state levels in the U.S. (and similar agencies in other countries) have been given the authority to set all relevant and necessary criteria (including strength and ability to withstand collisions, durability under various weather conditions, tolerably low levels of any leachates, etc.), the most straightforward way to determine whether this requirement has been met by some particular class of rubber-containing posts or spacer blocks is by requiring that such posts and/or spacer blocks must have been declared acceptable and suitable for taxpayer-funded purchase, and for use alongside one or more classes of public roads, by at least one governmental agency which is actually responsible for purchasing guardrails that will be installed alongside highways and/or other roads.

Installation of the type of assembly shown in FIG. 1 is typically carried out in the following manner. A circular hole 52 having a desired depth is created in ground surface 50 by any suitable means, which will depend on the type of ground surface involved (a powered auger can drill a hole into soil; a drill can drive small holes into concrete or rocks, and the remaining concrete or rock can then be broken into smaller pieces by jackhammers or other means; a cylindrical vacancy can be cast into concrete while it is being poured, etc.). Mounting post 40 is then lowered into hole 52, and the post is then surrounded and secured by filling the remainder of hole 52 with concrete, asphalt, soil, gravel, or any other suitable material 54.

After the post 40 has been securely emplaced in the ground 50, rail 20 and spacer block 30 (which also can be made of rubber particles from shredded tires, if desired) are secured to the upper end of post 40, by means such as bolt 42 which is secured by a washer and nut 44. Typically, galvanized steel bolts are used, having long shafts that are not threaded except near the tip. If desired, these bolts can be provided with “carriage bolt” heads, having square “shoulders” directly beneath the bolt head. These square shoulders can fit into an accommodating rectangular slot in trough 26 of rail 20, thereby preventing bolt 42 from rotating while nut 44 is being tightened on the backside of post 40.

Bolt 42 can pass all the way through holes that have been drilled through spacer block 30 and post 40. The holes can be drilled or otherwise formed during manufacturing if desired, but in at least some situations, it may be preferable to drill the holes through the mounting posts on-site, as part of the installation process, in order to allow minor adjustments in mounting height for a rail as it mounted on numerous support posts, to help ensure that the rail height stays relatively close to level (or has a consistent pitch), even across sloping or uneven terrain. It should be noted that rubber-containing posts as disclosed herein can be drilled fairly easily and quickly, on-site field locations, using conventional drill bits and drills (either handheld, or in a portable drill press that can be simply lowered onto the top of a post which is standing in the ground).

Alternately, “lag bolts” can be used, which have hexagon heads that can be gripped by a wrench to generate high levels of torque, and pointed ends that will screw directly into a rubber mounting post without emerging on the opposite side. Depending on the type of binder used to bind the rubber particles together, lag bolts can be used with or without pre-drilled pilot holes in the mounting posts.

Depending on design requirements for a certain stretch of guardrail, either one bolt or two bolts can be used at each mounting post to secure the guardrail to the mounting post.

In general, in order to provide maximal reinforcement and strength to a guardrail, the vertical height of a spacer block should be at least as tall as (or slightly taller than) the vertical width of a steel guardrail; stated in other words, the top and bottom of a spacer block should “back up” the entire guard rail, including its top and bottom edges. This type of “full backup” can help a W-shaped steel guardrail absorb as much destructive energy as possible, if a collision, scraping, or other accident occurs. By contrast, if a 14″ steel guardrail were mounting on a spacer block that is only 6″ or 8″ tall, then the upper and/or lower crests of the guardrail could be bent back fairly easily in a collision, in a manner that would cause the upper and/or lower portions of the guardrail to simply “wrap around” the spacer arm. If this type of “wrap-around” deformation were allowed to occur, the rail would not absorb much energy, and the damage to any cars (and potential injuries to passengers) could be substantially worse. Accordingly, since most steel guardrails used alongside highways have a vertical height of about 14 inches, spacer blocks designed for use with such guardrails should have a corresponding height. Accordingly, spacer blocks having dimensions of about 15 by 20 by 35 cm (about 6 by 8 by 14 inches) comprise a preferred embodiment that is likely to be widely useful for highway guardrails.

As another preferred embodiment, rubber-containing spacer devices (other than solid blocks) can be manufactured with open-circle, open-oval, open-square, U-shaped, N-shaped, or other geometric shapes, to provide a substantial degree of yielding resilience. This can further minimize damage to a car, and to a guardrail, if a collision or scraping accident occurs. It should be noted that this type of embodiment, using a “yielding” spacer device (which can contain bendable metallic straps for reinforcement, if desired) will not jeopardize the total strength, safety, and security provided by a guardrail, since the overall strength, safety, and security depend on the strength of the mounting posts, rather than the strength of the spacer blocks. If an “open-channel” spacer block which can yield is involved in a serious collision, it will simply flatten, to a point where the entire force of the collision will be transferred to the mounting post. That type of force transferral is the same thing that will happen instantaneously, if a non-yielding solid spacer block is used.

Molding and Extruding Operations

To convert the rubber particles into an elongated device that is sufficiently strong to serve as a guardrail mounting post or spacer block, the rubber particles are molded, under pressure and while suitable binding means are being applied (as discussed below, the terms “molded” and “molding” also include extrusion processes). Suitable binding means may include any or all of the following, or any combination thereof: (i) a chemical adhesive; (ii) a solvent which can effectively dissolve and soften the surfaces of some or all of the rubber particles; (iii) sufficient heat or other energy input to heat some or all of the rubber particles to a temperature where their surfaces soften and become sticky; and/or, (iv) any other known or hereafter-discovered binding means that can be adapted, in an economical manner, to a large-scale manufacturing operation involving rubber molding.

As used herein, any references herein to molding, molded, molds, etc. should be recognized as also including extrusion processing, as a subset of molding. As is well-known to those skilled in the art, extruding is a form of molding in which a thick paste-like fluidized material (which typically will have a consistency that is roughly comparable to cold peanut butter) is loaded into an extrusion feeder device, and then forced through an extruder outlet. This extruder outlet typically is created from a thick plate made of a very hard metal which has been laser-cut or machined to give it a desired shape, which will be imparted to the material that passes through the outlet. As the material (which can be, for example, a molten metal such as aluminum, or in this case, a fluidized mixture of rubber particles that have been melted and/or mixed with a chemical binder) is forced through the extruder outlet, it creates a “ribbon” of material having the desired cross-sectional shape and thickness. This ribbon is supported on a conveyor system (which can be an enclosed conveyor, if desired, having a tunnel-type structure with walls that can actively remove heat from the ribbon if desired), to ensure that the ribbon remains straight and does not suffer from bending, sagging, or other distortion due to the weight of the material. The conveyor system supports the ribbon of material until it hardens sufficiently to retain its shape, either through cooling of a molten or melted material, or due to curing, setting, and hardening of a chemical binder. At some point, the ribbon is cut into segments having desired lengths, and the segments are stacked, loaded onto a forklift pallet, or otherwise handled for storage, packaging, shipping, etc.

Extrusion manufacturing techniques are well-established and well-known, and are described in numerous patents and other references. This process is a subset of molding, since it is a form of continuous molding (as distinct from the “batch processing” type of molding that uses enclosed pressurized cavities). As in nearly any type of chemical manufacturing, continuous processing tends to be more efficient and economical than batch processing, and extrusion molding is regarded as a preferred method for creating guardrail mounting posts and spacer blocks as disclosed herein.

In general, it is believed and anticipated that preferred preparations of rubber particles for feedstock use as disclosed herein should contain a variety of particle sizes. To some extent, the desired size range will depend on whether cavity molding, or extrusion molding, is used to form the final products. In cavity molding, some of the particles should be moderately large chunks, having average diameters in a range of about 2 to 3 cm (about an inch) and possibly even larger, up to about 5 to 10 cm, or 2 to 4 inches. Chunks of this size range will act as tightly-bonded particles that do not require any internal binder, and thereby can minimize the total quantities and costs for chemical binders which must be added to the mixture. At the same time, smaller particles also should be present in the mixture, since they can occupy the “interstitial” spaces between the larger chunks, thereby further minimizing the quantities and costs of the relatively more expensive chemical binders that must be added to and mixed with the rubber particles. If extrusion molding is used, the preferred size range is likely to be narrower, and larger chunks generally are not preferred, since a large chunk might be rotated or displaced if it catches against an edge of the extruder outlet, and might create a void or defect in the final product.

Accordingly, preferred and optimal “blends” of particle sizes can be evaluated for either cavity or extrusion molding, using mixtures of particles having sorted, controlled, and known size ranges. Sorting and sizing machines which can generate particle preparations having any desired size range are well-known. By testing various combinations of size-controlled preparations, and by factoring in the cost per kilogram or pound of the chemical binder that is being evaluated for use as disclosed herein, preferred and optimal blends of particle sizes can be determined.

As a hypothetical example, if cavity molding is being used to create 6 by 8 inch posts that are six feet long and do not contain any reinforcing rods, and if molding pressures of 500 pounds per square inch are being evaluated, particle-size testing as described above (which can be carried out using no more than routine procedures) may reveal that, with a particular type of adhesive is used, the lowest-cost particle blend for molding posts that can achieve a 97% quality control level, when tested for ability to withstand a standardized bending force imposed over a 6-foot length, should contain, by weight, 20% as chunks with average diameters between 1.5 and 2.5 inches, 30% as chunks with diameters between 0.7 and 1.5 inches, 30% as particles with diameters between 0.2 and 0.7 inch, and 20% as particles with diameters of less than 0.2 inch.

Once a desired size range is known for use with a specific type of molding machine, appropriate steps can be taken to create an appropriate mixture of such particles, by steps which can include, for example: (i) altering and testing various operating parameters of the shredding equipment, including the thickness, diameter, and rotating speed of the shredding disks, the amount of pressure imposed on tires as they are being forced into the shredding disks, the shape(s) of the cutting surfaces on the rotating disks, and the sizes of tire sections which are being pressed into the shredding disks; (ii) blending together the shredded output from two or more shredding machines having different traits or operating parameters; (iii) creating particulate mixtures having smaller size ranges by carrying out a “second pass” shredding operation on chunks that have already passed through the same or a different shredding machine; and/or, (iv) blending together two or more controlled-size particulate mixtures that have been sorted in size-sorting machines.

It should be recognized that such testing and optimization is much less important for spacer blocks than for mounting posts, since spacer blocks are much shorter, and do not need to be designed to withstand high shear and bending forces during a collision. Accordingly, since spacer blocks will be developed and commercialized first, and will be followed by the development, testing, and commercialization of mounting posts over a span of years, the types of testing and development that will be required to generate optimal manufacturing parameters for mounting posts can be carried out in due course.

It also should be recognized that this type of testing is for economic rather than technical purposes, and is designed to help reduce the total costs of production. These types of tests are not required for technical reasons, since the disclosures herein can be used to create spacer blocks and or mounting posts with entirely adequate strength and performance.

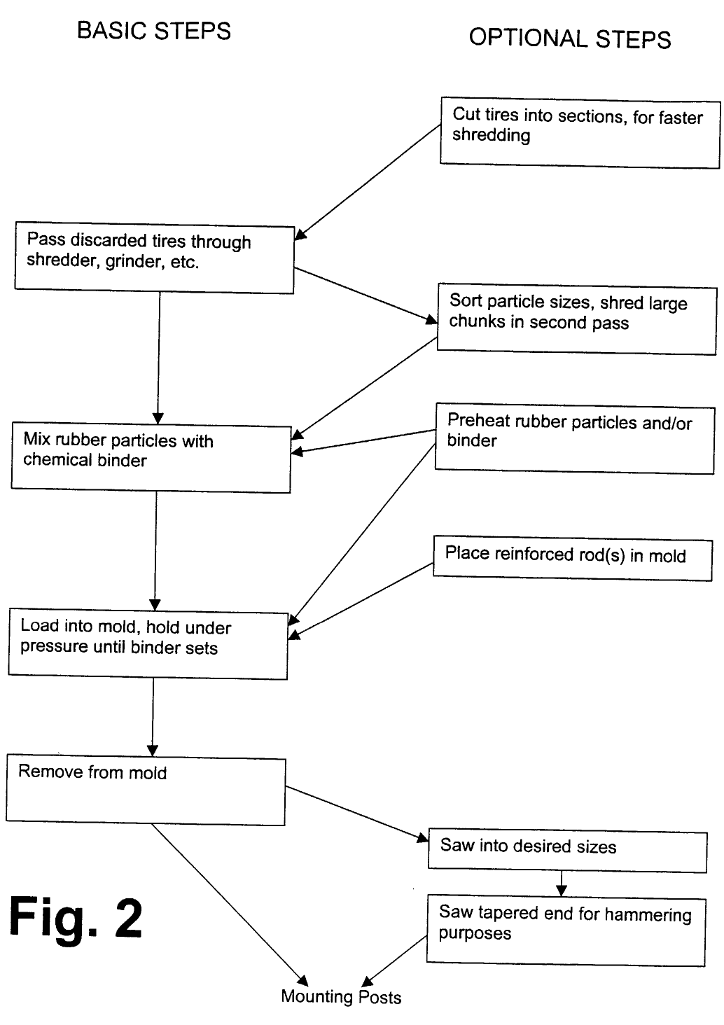

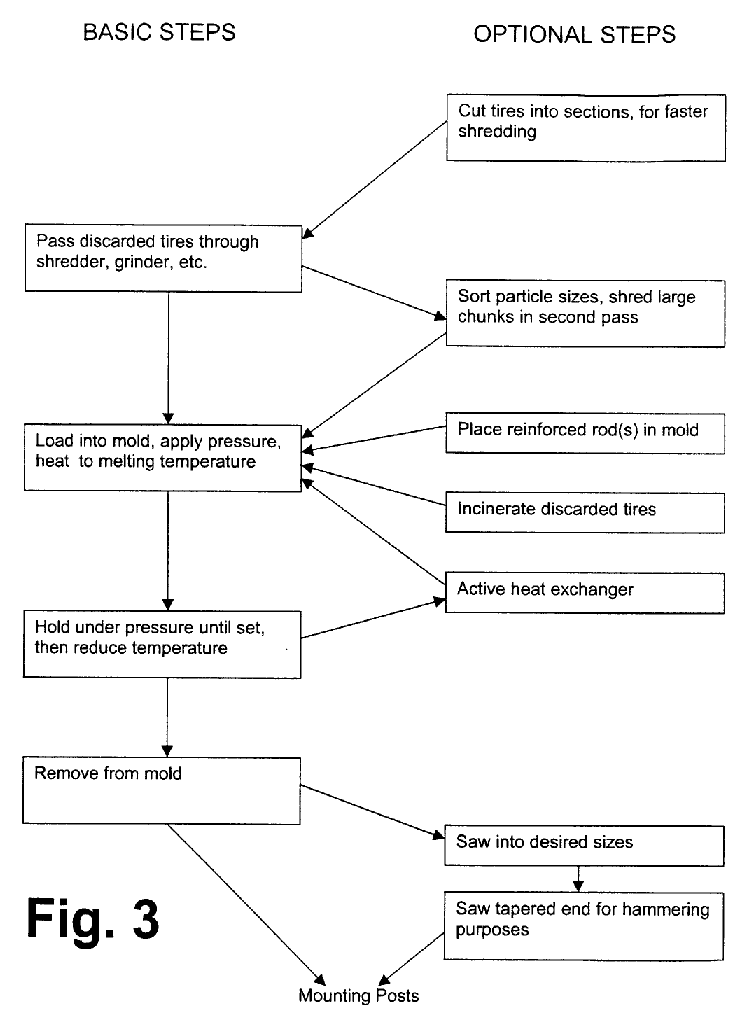

FIGS. 2 and 3 provide flow charts which depict various steps that can be used to manufacture mounting posts from recycled rubber particles. Spacer blocks can be made in the same way, and also can be made by simply making a mounting post (or an even longer post), and then sawing it into shorter lengths, after it has been removed from a mold. These two figures focus primarily on batch-type molding operations, which use molding cavities; the processes for use in extrusion molding are very similar, and can be adapted by those skilled in the art.

In the process shown in FIG. 2, an adhesive or other chemical binder (such as a low-melt polymer, such as virgin or recycled polyolefin particles, or a solvent that can render the surfaces of rubber particles soft and sticky) is used to bind the rubber particles together. In an alternate process shown in FIG. 3, high temperatures which are sufficient to melt or soften the surfaces of the rubber particles (or a low-melt polymer additive, such as virgin or recycled polyolefin particles) is used as the primary or sole binding means. In both of these two flow charts, various basic steps are listed in the left column, while additional optional steps are depicted in the right column.

In the most basic process using a chemical binder, as shown in FIG. 2, discarded tires must be shredded, to form rubber particles. However, it's not essential that this be done at the same site where the tires are manufactured, or by the same company; if a company chooses to buy rubber particles (sometimes called “crumb rubber”) that have already been shredded from discarded tires, it can use those rubber particles as its feedstock. The shredding operation may be carried out by using various optional steps, such as: (i) cutting the tires into halves, quarters, or other sections, to speed up the pass-through rates that can be achieved with the shredding machines; and/or, (ii) using a process as described above, to create an economically optimized range and combination of particle sizes.

The rubber particles from shredded tires are then mixed with the chemical binder, using suitable machinery (which can include any combination of augers, stirrers, rotating drums, or other mixing machines) which can ensure a high degree of surface coating of the rubber particles. If desired, the rubber particles and/or chemical binder can be heated, either shortly before or during mixing, or shortly before or after they are loaded into a mold; in some cases, this can reduce the viscosity of the chemical binder and/or the rubber-binder mixture, and can help ensure more thorough and even coating of all rubber particles, by the binder. If desired, the chemical binder can be in a powdered, granular, pelleted, or other semi-solid form when mixed with the rubber, if the mold will be subjected to a heating process that will melt the binder during the setting reaction (as used herein, “setting” refers to the stage, during a molding operation, when a chemical binder passes from a liquified state into a solidified state, or when the rubber particles are cooled down from a melted, liquified, or other softened state into a cooler hardened state; the “setting” process can also be referred to as curing, hardening, etc.).

Suitable chemical binders which will adhere tightly to the surfaces of rubber particles from shredded tires, and which have other desirable traits (such as being impervious to water, able to withstand very low temperatures, resistant to degradation by sunlight, etc.) are known in the art. Several examples are listed in U.S. Pat. Nos. 5,094,905 and 5,238,734 (cited above; issued to Murray, and now owned by the Applicant herein). Various other suitable binders are known, and can be specified by any company that markets such adhesives. Any candidate binder compound or mixture can be tested to evaluate its suitability for use as described herein, using no more than routine experimentation.

It also should be noted that two-component binders (such as an epoxy-type adhesive, in which two different chemicals must be mixed together and then coated onto the rubber particles) can be used if desired. In particular, one class of two-component binder which is worth noting, and which can be evaluated for use as disclosed herein, comprises mixtures that will release gas bubbles soon after the two components are mixed together. One example of such a mixture comprises a class of compounds known as isocyanate-polyurethane mixtures. If gas bubbles are released by a two-component adhesive mixture shortly after the two components are mixed, they may be able to promote either or both of two different potentially useful goals: (i) the release of gas bubbles, during a “foaming” or “creaming” stage, can help ensure that the liquid residue which results from the chemical reaction will thoroughly contact and coat all surfaces in a complex and dense particulate mixture; and (ii) if the gas bubbles are trapped inside the final molded product, they can reduce the density and weight of the final product.

Any known or hereafter-discovered method, tool, machine, or compound that can increase the efficiency of any type of molding operation can be evaluated, if desired, to determine whether that method, tool, machine, or compound can increase the efficiency, improve the final product, or reduce the total costs of a molding operation as disclosed herein. As one example, the settling, compaction, and density of dry particles resting in a molding tray or cavity usually can be increased, by subjecting them to a vibrating motion. This higher level of compaction can reduce the volume of an expensive chemical adhesive which must fill (or nearly fill) the interstitial spaces between the particles. Accordingly, if the viscosity of a selected adhesive (which can be heated to reduce its viscosity, if desired) is low enough to allow the adhesive to permeate (under pressure, if desired) through a bed of rubber particles that are already resting in a molding tray, then the rubber particles can be subjected to a vibrating action, to promote additional settling, before a liquid adhesive is added.

Alternately or additionally, a vibrating treatment to increase settling can also be used if a granular, powdered, or other particulate binder is used.

These are just two examples, and various other such techniques are already known to those skilled in the art.

Because rubber particles from shredded tires will not be the sole and exclusive constituent of various types of molded mounting posts or spacer blocks as disclosed herein, the claims refer to the rubber particles as a “major constituent” of such posts or blocks. This phrase means and implies that rubber particles from shredded tires will comprise the majority of the bulk and weight of such posts or blocks, excluding any chemical binders and any reinforcing rods or beams.

One of the primary goals of this application is to disclose that using rubber from shredded discarded tires provides an ideal way to recycle discarded tires, and it is believed to be entirely possible to manufacture such guardrails entirely from shredded tires, adding no other materials other than a chemical adhesive or binder. Nevertheless, it also should be recognized that other materials (such as recycled plastics, and recycled nylon fibers from shredded discarded carpets, as just two examples) can also be added to the rubber mixture, if desired. This can offer a good way to recycle such other materials, and in some cases, such added materials may also provide certain additional advantages to the final product (for example, adding recycled nylon fibers from shredded carpet segments may increase the strength, resilience, or other desired traits of the resulting posts or blocks). Accordingly, various claims refer to mounting posts or spacer blocks which contain rubber particles from shredded tires as a “primary constituent”. This term is intended to indicate that rubber particles from shredded tires form at least a majority, and preferably at least about 70% or more (by weight), of all non-binder constituents that form a mounting post or spacer block.

If a guardrail mounting post is intended to be hammered into the ground, or if it is designed to be relatively long, one or more reinforcing rods or other load-resisting devices (such as an I-beam), made of steel, graphite, or a suitably hard composite material, can be emplaced in the mold, either before or shortly after the rubber-binder mixture is loaded into the mold. In addition, to reduce bending forces on a post that is to be hammered into the ground, the bottom end of the post can be molded, sawed, or otherwise shaped in a manner that provides a tapered bottom end 62, as shown on post 60 in FIG. 4. FIG. 4 also shows a reinforcing rod 64 positioned in the center of post 60, protruding from the bottom end 62; in most cases, this type of reinforcing rod can simply be a segment of a standard concrete reinforcing rod, as used in most types of molded concrete structures.

As briefly mentioned above, most guardrail posts typically have lengths of about 1 to about 2 meters, or 3 to 6 feet, and square or rectangular cross-sections ranging from about 10 to 15 cm, or 4 to 6 inches, on each side. However, guardrail posts often are substantially thicker, for greater strength, in locations along high-speed highways, and in cliffside, waterside, and similar locations where “snapoff” breakage in a collision could have especially severe or dangerous consequences. Accordingly, wooden guardrail posts intended for such locations often have thicknesses in the range of 8, 10, or even 12 inches, and are often made in round shapes, comparable to sawed-off segments of telephone poles. Mounting posts made from shredded tires as disclosed herein can have similar or even greater thicknesses, if desired, and can be reinforced with multiple reinforcing posts made of steel or other hardened materials.

If cavity-type molding is used, the mold(s) can be designed in any manner that is suited for an economical mass-manufacturing operation. For example, in one embodiment, two or more cavities can be provided in a tray or other array, and each cavity can be used to mold a single mounting post, in each molding operation. If this approach is taken, additional tightening and/or reinforcing components (such as threaded bolts, extending upward from the bottom tray in positions that will pass through accommodating holes in the mold lid, so that large wing nuts or similar tightening devices can be tightened onto the protruding bolts after the lid has been lowered onto the tray) can be provided at suitable spaced locations around the tray and lid.

As another embodiment, an oversized cavity can be used to create an oversized rectangle of solidified molded material. After the solidified material has been removed from the mold, it can then be sawed or otherwise cut into two or more mounting posts, with each post having the desired dimensions.

Similarly, if desired, both ends of a mounting post can be blunt; or, alternately, one end can be angled or tapered to an edge or point having an acute angle, as shown in FIG. 4, to facilitate driving or hammering the post into the ground.

If high temperatures (i.e., temperatures high enough to cause melting or softening of all or a large fraction of the rubber particles) are used to mold rubber particles into mounting posts, either alone or in conjunction with a chemical binder, then the molding process should be modified and adapted in various ways, including in certain manners indicated in FIG. 3 (and in other respects that will be apparent to those skilled in such manufacturing operations). In general, instead of mixing the rubber particles with a chemical binder prior to loading the mixture into a mold, the rubber particles (with additional materials mixed in, if desired) are loaded into a mold (or extrusion feeder), and the mold (or extrusion feeder) is then heated to a temperature which causes melting or softening of the rubber contained therein. In general, if at least some level of pressure is applied to a molding tray during the heating process, then heat transfer between the walls of the tray and the rubber particles will be greater and more efficient. Optimal heating and pressure cycles and durations, during a molding operation, can be developed using routine experimentation, and will be roughly comparable to molding tires out of rubber, but requiring lower levels of precision.

As the heating and pressure cycle nears completion, the temperature is reduced, in order to cool and further solidify the molded rubber. To reduce overall energy costs, this can be done with the aid of a heat exchanger, involving cooling tubes that will carry a liquid (presumably water) across one or more the surfaces of the mold. The water, which will become hot during the process, can then be used to heat up the next batch of rubber particles, at or near the start of a molding and heating cycle.

If high temperatures are used to melt rubber during a molding process that uses molding trays or cavities rather than extrusion, it likely will be preferable to use each cavity in a molding tray to mold a single mounting post or spacer block. If larger blocks of molded material were created by a heating process, to be sawed into smaller blocks after the heating and molded process was completed, a serious risk would arise that burning or charring of the outer surfaces of the larger block of material would occur.

If a heating step is used during a molding operation, the energy input can be provided in any suitable manner, including by incinerating discarded tires. This can be done by various types of incinerators, such as the types of kilns used to manufacture cement, or the type of incinerator described in U.S. Pat. No. 5,322,026 (Bay 1994), in which three sequential combustion zones are used to achieve more complete and thorough combustion, to minimize emissions of unburned particulates and hydrocarbons.

One of the advantages of using rubber materials derived from recycled tires is that when such materials are made using conventional low-cost binders, they can be sawed, drilled, nailed, and otherwise treated in a manner directly comparable to wood, and without requiring special types of saw blades or drill bits. Since this type of cutting, drilling, etc., does not render these rubber materials brittle or fragile, this leads to various advantages when working with these types of rubber materials in an outdoor setting. For example, the guardrails, mounting posts, and spacer blocks disclosed herein can be sawed or drilled on-site, quickly, easily, and with conventional low-cost blades and bits. This will allow any necessary cuts, holes, slots, etc., to be created quickly and easily, while a guardrail is being installed, rather than requiring higher levels of skill and precision to assemble premanufactured components into a complete system alongside a highway.

These mounting posts and spacer blocks are expected to have substantially longer “design lifes” (i.e., functional lifespans, so long as they are not severely damaged in a collision caused by a car or truck) than mounting posts or spacer blocks made of treated wood. Among other factors, the built-in flexibility that arises from having a high rubber content in these posts and blocks greatly reduces their tendency to crack, split, and show other signs of deterioration or weakening when subjected to multiple cycles of wetting, freezing, and thawing. In addition, because they are made from the same type of rubber used in tires, they cannot be damaged by insects, and do not offer a hospitable surface (with digestible sources of carbon, phosphorous, or nitrogen) for mold, mildew, fungus, or other microbes. Because no one can yet say with any certainty just how long these posts will last under various conditions, and because the design life for any post will depend heavily on the weather and environment where it is installed, it is impossible to specify precise design lifes for these posts; however, it is believed and anticipated that the design life for these posts will be substantially longer than for treated wood, and is likely to be longer than 10 years even when installed under the most hostile and adverse conditions that exist anywhere in the North American continent below the arctic circle.

It should be noted that the claims below refer to “a plurality of” mounting posts or spacer blocks. This phrase reflects two important facts. First, although a wide variety of manufactured articles might arguably be said to offer something that could be used or adapted as a mounting post for a guardrail, this invention and the claims below are not intended to read upon any prior art that has not actually been used as a guardrail mounting post.

And second, this invention and the claims below are not intended to read upon or cover any single device that might arguably be potentially useful as a single guardrail post. Instead, this invention and application are intended to disclose a manufacturing process that can be used to create thousands and even millions of thick and heavy mounting posts, which will endure for decades without attracting insects or leaching out toxic chemicals while sitting outdoors under all kinds of weather conditions, by using rubber from discarded tires that otherwise will continue to create terrible solid waste and public health problems. Accordingly, it is anticipated that the guardrail posts disclosed herein will be manufactured and sold, not in lots of ten or a dozen at a time, but in lots of hundreds or thousands at a time.

Accordingly, in addition to claiming “a plurality of mounting posts”, certain claims also refer to “an article of manufacture, comprising a pallet designed for lifting by a forklift, and a plurality of mounting posts resting upon the pallet”. This type of pallet-and-posts assembly 70 is shown in FIG. 5, with a conventional wooden pallet 80 comprising a horizontal base 82, with loading surface 84 supported by braces 85, 86, and 87, so that the spaces (or gaps) 88 and 89 between braces 85-87 can accommodate the prongs of a forklift. Multiple posts 90 are stacked on top of pallet 80, and are secured in place by conventional steel, nylon, or similar straps 92. This type of “loaded pallet” will be the most common and convenient way to package posts or spacer blocks as disclosed herein, for handling and shipping.

Thus, there has been shown and described new and useful types of mounting posts and spacer blocks, for guardrails and similar safety devices, made from rubber particles from shredded discarded tires. Although this invention has been exemplified for purposes of illustration and description by reference to certain specific embodiments, it will be apparent to those skilled in the art that various modifications, alterations, and equivalents of the illustrated examples are possible. Any such changes which derive directly from the teachings herein, and which do not depart from the spirit and scope of the invention, are deemed to be covered by this invention.

1. A plurality of guardrail mounting posts, comprising posts that are sized and designed for mounting guardrails alongside a roadway, wherein each mounting post is suited in all respects for emplacement in an augured hole next to a roadway and, after a series of such mounting posts are secured in such holes, to have a guardrail securely affixed to said series of mounting posts, wherein the plurality of guardrail mounting posts have been manufactured by a molding process that utilizes rubber particles from shredded tires as a major constituent, and wherein the mounting posts can be sawed and drilled in a manner comparable to wood.

2. The plurality of guardrail mounting posts of claim 1, wherein the guardrail mounting posts are also characterized by the absence of a surface coating made of plastic or metal.

3. The plurality of guardrail mounting posts of claim 1, wherein the posts are not subject to damage by insects, and cannot be damaged when coated by or submerged in water and subsequently subjected to repeated cycles of freezing and thawing, and have design lives of greater than 10 years when installed alongside a roadway.

4. The plurality of guardrail mounting posts of claim 1, wherein each post has a first end suited for lowering into the ground, and a second end which has been drilled or can be drilled with holes for receiving mounting bolts.

5. The plurality of guardrail mounting posts of claim 1, wherein the posts have been manufactured by steps which include:
a. mixing rubber particles from shredded tires with a chemical binder compound, to create a moldable mixture;
b. placing the moldable mixture inside a molding device;
c. subjecting the moldable mixture inside the molding device to elevated pressure while the chemical binder compound sets and hardens, thereby creating a hardened and solidified molded item;
d. removing the molded item from the molding device.

6. The plurality of guardrail mounting posts of claim 1, wherein the posts have been manufactured by steps which include:
a. emplacing rubber particles from shredded tires in a molding device;
b. imposing elevated pressure on the rubber particles inside the molding device;
c. heating the rubber particles inside the molding device to temperatures which are sufficiently high to soften and melt at least some of the rubber particles, for a period of time sufficient to create a melted material that will become cohesive after cooling;
d. allowing the melted material to cool until it becomes cohesive and forms a molded item; and,
e. removing the molded item from the mold.

7. The plurality of guardrail mounting posts of claim 1, wherein the posts have been manufactured by steps which include:
a. creating an extrudable preparation containing rubber particles from shredded tires;
b. forcing the extrudable preparation through an extruder outlet in a manner which imparts a desired cross-section to extruded material; and,
d. cutting the extruded material into segments having lengths that render the segments useful as guardrail mounting posts.

8. An article of manufacture, comprising a pallet designed for lifting by a forklift, and a plurality of guardrail mounting posts of claim 1 resting upon the pallet and secured to the pallet.

9. A guardrail mounting post, comprising an elongated solid structure having a thickness, length, and strength which render it suitable in all respects for mounting and supporting a guardrail along a roadway, and having levels of strength and durability which have been declared acceptable to a governmental agency which is responsible for purchasing guardrails for installation along highways, wherein the guardrail mounting post has been manufactured by a molding process that utilizes rubber particles obtained from shredded discarded tires as a major constituent, and wherein the mounting post can be sawed and drilled in a manner comparable to wood.

10. The guardrail mounting post of claim 9, also characterized by the absence of a surface coating made of plastic or metal.

11. The guardrail mounting post of claim 9, also characterized by high resistance to damage by insects and by repeated cycles of freezing and thawing when wet, and having a design life of greater than 10 years when installed alongside a roadway.

12. The guardrail mounting post of claim 9, which has been manufactured by steps which include:
a. mixing rubber particles from shredded tires with a chemical binder compound, to create a moldable mixture;
b. placing the moldable mixture inside a molding device;
c. subjecting the moldable mixture inside the molding device to elevated pressure while the chemical binder compound sets and hardens, thereby creating a hardened and solidified molded item; and,
d. removing the molded item from the molding device.

13. The guardrail mounting post of claim 9, which has been manufactured by steps which include:
a. emplacing rubber particles from shredded tires in a molding device;
b. imposing elevated pressure on the rubber particles inside the molding device;
c. heating the rubber particles inside the molding device to temperatures which are sufficiently high to soften and melt at least some of the rubber particles, for a period of time sufficient to create a melted material that will become cohesive after cooling;
d. allowing the melted material to cool until it becomes cohesive and forms a molded item; and,
e. removing the molded item from the mold.

14. The guardrail mounting post of claim 9, which has been manufactured by steps which include:
a. creating an extrudable preparation containing rubber particles from shredded tires;
b. forcing the extrudable preparation through an extruder outlet in a manner which imparts a desired cross-section to extruded material; and,
d. cutting the extruded material into a segment having a length that renders the segment useful as a guardrail mounting post.

15. An article of manufacture, comprising a pallet designed for lifting by a forklift, and a plurality of guardrail mounting posts of claim 9 resting upon the pallet and secured to the pallet.

16. A guardrail spacer block for attaching a guardrail to a mounting post, comprising a molded device having dimensions and strength which render it suitable for use in a highway guardrail structure, and containing as a major constituent rubber particles from shredded tires.

17. The guardrail spacer block of claim 16, having at least one hole passing entirely therethrough to accommodate a mounting bolt.

18. The guardrail spacer block of claim 16, which has been manufactured by steps that include:
a. mixing rubber particles from shredded tires with a chemical binder compound, to create a moldable mixture;
b. placing the moldable mixture inside a molding device;
c. subjecting the moldable mixture inside the molding device to elevated pressure while the chemical binder compound sets and hardens, thereby creating a hardened and solidified molded item; and,
d. removing the molded item from the molding device.

19. The guardrail spacer block of claim 16, which has been manufactured by steps that include:
a. emplacing rubber particles from shredded tires in a molding device;
b. imposing elevated pressure on the rubber particles inside the molding device;
c. heating the rubber particles inside the molding device to temperatures which are sufficiently high to soften and melt at least some of the rubber particles, for a period of time sufficient to create a melted material that will become cohesive after cooling;
d. allowing the melted material to cool until it becomes cohesive and forms a molded item; and,
e. removing the molded item from the mold.

20. The guardrail spacer block of claim 16, which has been manufactured by steps that include:
a. creating an extrudable preparation containing rubber particles from shredded tires;
b. forcing the extrudable preparation through an extruder outlet in a manner which imparts a desired cross-section to extruded material; and,
d. cutting the extruded material into a segment having a length that renders the segment useful as a guardrail spacer block.

21. An article of manufacture, comprising a pallet designed for lifting by a forklift, and a plurality of guardrail spacer blocks of claim 16 resting upon the pallet and secured to the pallet.

22. A method for manufacturing a guardrail mounting post, comprising the steps of:
a. creating a moldable mixture that contains, as a primary constituent, rubber particles from shredded tires; and,
b. molding the moldable mixture into a hardened device that has sufficient strength and durability to meet or exceed all specifications for guardrail mounting posts, issued or adopted by at least one government agency that is responsible for purchasing guardrails for installation along highway.

23. The method of claim 22, wherein the molding is carried out by steps comprising:
a. creating a moldable mixture of rubber particles from shredded tires, mixed with a chemical binder;
b. emplacing the moldable mixture inside a molding cavity;
c. subjecting the moldable mixture, while in the molding cavity, to elevated pressure while the chemical binder compound sets and hardens, thereby creating a solidified molded item; and,
d. removing the solidified item from the molding cavity.

24. The method of claim 22, wherein the molding is carried out by steps comprising:
a. emplacing rubber particles from shredded tires in a molding device;
b. imposing elevated pressure on the rubber particles inside the molding device;
c. heating the rubber particles inside the molding device to temperatures which are sufficiently high to soften and melt at least some of the rubber particles, for a period of time sufficient to create a melted material that will become cohesive after cooling;
d. allowing the melted material to cool until it becomes cohesive and forms a molded item; and,
e. removing the molded item from the mold.

25. The method of claim 22, wherein the molding is carried out by steps comprising:
a. creating an extrudable preparation containing rubber particles from shredded tires;
b. forcing the extrudable preparation through an extruder outlet in a manner which imparts a desired cross-section to extruded material; and,
d. cutting the extruded material into a segment having a length that renders the segment useful as a guardrail mounting post.

26. A method for manufacturing a guardrail spacer block, comprising the steps of:
a. creating a moldable mixture that contains, as a primary constituent, rubber particles from shredded tires; and,
b. molding the moldable mixture into a hardened device.

27. The method of claim 26, wherein the molding is carried out by steps comprising:
a. creating a moldable mixture of rubber particles from shredded tires, mixed with a chemical binder;
b. emplacing the moldable mixture inside a molding cavity;
c. subjecting the moldable mixture, while in the molding cavity, to elevated pressure while the chemical binder compound sets and hardens, thereby creating a solidified molded item; and,
d. removing the solidified item from the molding cavity.

28. The method of claim 26, wherein the molding is carried out by steps comprising:
a. emplacing rubber particles from shredded tires in a molding device;
b. imposing elevated pressure on the rubber particles inside the molding device;
c. heating the rubber particles inside the molding device to temperatures which are sufficiently high to soften and melt at least some of the rubber particles, for a period of time sufficient to create a melted material that will become cohesive after cooling;
d. allowing the melted material to cool until it becomes cohesive and forms a molded item; and,
e. removing the molded item from the mold.

29. The method of claim 26, wherein the molding is carried out by steps comprising:
a. creating an extrudable preparation containing rubber particles from shredded tires;
b. forcing the extrudable preparation through an extruder outlet in a manner which imparts a desired cross-section to extruded material; and,
d. cutting the extruded material into a segment having a length that renders the segment useful as a guardrail spacer block.
